(19) United States
(12) Patent Application Publication
(10) Pub. No.: US 2021/0333008 A1
(43) Pub. Date: Oct. 28, 2021

(54) ADVANCED ELECTRIC HEATING

(71) Applicant: Carrier Corporation, Palm Beach Gardens, FL (US)

(72) Inventor: Srinivasa Reddy Pilli, Hyderabad (IN)

(21) Appl. No.: 17/301,872

(22) Filed: Apr. 16, 2021

(30) Foreign Application Priority Data
Apr. 23, 2020 (IN) 202011017455

(51) Int. Cl. F24F 12/00; F28D 9/00

(52) U.S. Cl. CPC F24F 12/006; F24F 2203/1068; F24F 2203/104; F28D 9/0062

(57) ABSTRACT

A heat exchanger including at least one bulb configured to generate a heat, and a heating, ventilation, and/or air conditioning (HVAC) system incorporating the same are provided. The heat exchanger includes a body configured to permit the passage of an airflow through at least a portion of the body. The body includes at least one pocket with an interior surface. The pocket(s) may be configured in parallel or perpendicular to the passage of the airflow. The heat exchanger includes at least one bulb configured within at least one pocket. At least a portion of the heat generated by the bulb is transferred to at least a portion of the airflow. The pocket may allow the heat to be transferred to the airflow without the airflow contacting the bulb.

### CROSS REFERENCE TO A RELATED APPLICATION

The application claims the benefit of India Provisional Application No. 202011017455 filed Apr. 23, 2020, the contents of which are hereby incorporated in their entirety.

### BACKGROUND

Modern heating, ventilation, and/or air conditioning (HVAC) systems may include one or more electric heating components to transfer heat to an airflow (e.g., to provide heating to a residential or commercial space). Electric heating components are electrical devices that convert electric current into heat. To convert electrical current into heat, each electric heating component typically includes a resistance element. These electric heating components are commonly referred to as “electric heat exchangers” or “heat exchangers”.

One example of a residential HVAC system that includes an electric heat exchanger to transfer heat to an airflow is an electric furnace. Electric furnaces typically include both a heat exchanger and a fan. The fan draws air into the furnace and forces the air through the heat exchanger. The heat exchanger transfers at least a portion of the heat energy it generates to the air passing through heat exchanger.

One example of a commercial HVAC system that includes an electric heat exchanger to transfer heat to an airflow is a duct incorporating an electric duct heater. Like the residential HVAC system (e.g., the furnace), the commercial HVAC system typically includes both a heat exchanger (e.g., the electric duct heater) and a fan, which may be incorporated within the duct to force air through the duct.

One issue with using electric heat exchangers is the need for regular maintenance to make sure the resistance elements within the electric heat exchangers have connectivity. Electric heat exchangers commonly lose connectivity when coming into direct contact with moist air (e.g., air with a high humidity). This is a common problem as HVAC systems traditionally are not designed to prevent moist air from contacting the resistance elements. The replacement of these resistance elements can be costly both in terms of product replacement and in terms of system downtime, as the removal/replacement of a conventional resistance element is not an easy process.

Accordingly, there remains a need for an electric heat exchanger that is capable of transferring heat to an airflow while preventing, or at least mitigating, the airflow from contacting the resistance element, the resistance element being incorporated within the electric heat exchanger in a way that is easier and cheaper to replace than existing electric heat exchangers.

### BRIEF DESCRIPTION

According to one embodiment, a heat exchanger including a body with at least one bulb is provided. The body is configured to permit the passage of an airflow through at least a portion of the body. The body includes at least one pocket. The pocket includes an interior surface. At least one bulb is configured within at least one pocket. The bulb configured to generate a heat. At least a portion of the heat is transferred to at least a portion of the airflow.

In accordance with additional or alternative embodiments, each pocket is configured parallel to the passage of the airflow.

In accordance with additional or alternative embodiments, each pocket is configured perpendicular to the passage of the airflow.

In accordance with additional or alternative embodiments, each bulb is supported within each pocket by a plate. The plate is configured to prevent the bulb from coming into contact with the interior surface of the pocket.

In accordance with additional or alternative embodiments, each bulb is configured to receive an electrical power. Each bulb is configured to convert approximately 90% of the electrical power to heat and approximately 10% of the electrical power to light.

In accordance with additional or alternative embodiments, the interior surface of the pocket includes a black solar coating. The black solar coating is configured to convert at least a portion of the light generated by the bulb to heat.

In accordance with additional or alternative embodiments, the black solar coating is made of a plurality of nano-crystalline layers.

In accordance with additional or alternative embodiments, the black solar coating has an emissivity less than 40%.

In accordance with additional or alternative embodiments, the pocket prevents substantially all of the airflow from coming into contact with the bulb.

In accordance with additional or alternative embodiments, the body includes a plurality of fins. Each fin is respectively made of a metal, the metal includes at least one of: aluminum, steel, and copper.

In accordance with additional or alternative embodiments, the body includes an extruded metal. The metal includes at least one of: aluminum, steel, and copper.

In accordance with additional or alternative embodiments, the bulb is a halogen bulb.

In accordance with additional or alternative embodiments, the body includes at least four pockets and the heat exchanger includes at least four bulbs. Each respective bulb configured within a pocket.

According to another aspect of the disclosure a heating, ventilation, and/or air conditioning (HVAC) system is provided. The HVAC system includes a heat exchanger and a fan in airflow communication with the heat exchanger. The heat exchanger includes a body with at least one bulb. The body is configured to permit the passage of an airflow through at least a portion of the body. The body includes at least one pocket. The pocket includes an interior surface. At least one bulb is configured within at least one pocket. The bulb is configured to generate a heat. At least a portion of the heat is transferred to at least a portion of the airflow.

In accordance with additional or alternative embodiments, the heat exchanger is disposed adjacent to the fan.

In accordance with additional or alternative embodiments, the HVAC system further includes a duct, the heat exchanger disposed a distance from the fan in the duct.

In accordance with additional or alternative embodiments, each pocket is configured parallel to the passage of the airflow.

In accordance with additional or alternative embodiments, each pocket is configured perpendicular to the passage of the airflow.

In accordance with additional or alternative embodiments, the pocket prevents substantially all of the airflow from coming into contact with the bulb.

In accordance with additional or alternative embodiments, the heat exchanger includes at least one of: a plurality of fins and an extruded metal.

### BRIEF DESCRIPTION OF THE DRAWINGS

The subject matter, which is regarded as the disclosure, is particularly pointed out and distinctly claimed in the claims at the conclusion of the specification. The following descriptions of the drawings should not be considered limiting in any way. With reference to the accompanying drawings, like elements are numbered alike:

FIG. 1 is a perspective view of a heating, ventilation, and/or air conditioning (HVAC) system with a heat exchanger including at least one bulb in accordance with one aspect of the disclosure.

FIG. 2 is a perspective view of a heat exchanger, as shown in FIG. 1, with at least one bulb in accordance with one aspect of the disclosure.

FIG. 3 is a cross-sectional view taken along cross-sectional line A-A from FIG. 2, depicting a heat exchanger with two bulbs configured in parallel to the passage of the airflow in accordance with one aspect of the disclosure.

FIG. 4 is a perspective view of a heating, ventilation, and/or air conditioning (HVAC) system with a heat exchanger including at least one bulb in accordance with one aspect of the disclosure.

FIG. 5 is a perspective view of a heat exchanger, as shown in FIG. 4, with at least one bulb in accordance with one aspect of the disclosure.

FIG. 6 is a cross-sectional view taken along cross-sectional line B-B from FIG. 5, depicting a heat exchanger with one bulb configured in perpendicular to the passage of the airflow in accordance with one aspect of the disclosure.

FIG. 7 is a perspective view of a heating, ventilation, and/or air conditioning (HVAC) system with a heat exchanger including at least one bulb, the heat exchanger disposed a distance away from a fan in a duct in accordance with one aspect of the disclosure.

FIG. 8 is a cross-sectional view taken along cross-sectional line C-C from FIG. 7, depicting the heat exchanger being disposed within a duct of the HVAC system in accordance with one aspect of the disclosure.

### DETAILED DESCRIPTION

A heat exchanger including at least one bulb (e.g., a halogen bulb) configured within at least one pocket, and a heating, ventilation, and/or air conditioning (HVAC) system incorporating the same are provided. Each bulb is configured to generate heat, at least a portion of which is transferred to a least a portion of an airflow passing through the heat exchanger. The heat exchanger, through incorporating at least one bulb within at least one pocket, may be able to prevent, or at least mitigate, the airflow from contacting the resistance element (e.g., each bulb). This may prevent the bulb from coming into contact with moist air, which could otherwise damage the bulb.

Additionally, by incorporating each bulb within a pocket, each bulb may be may be replaced in a relatively simple manner (e.g., when compared to the replacement of existing resistance elements). For example, to replace a bulb, a person may simply disengage (e.g., by rotating counter-clockwise) and pull the existing bulb from the heat exchanger, and then insert and engage a new bulb. It should be appreciated that the heat exchanger with at least one bulb may be used within any configuration of an HVAC system, however, for purposes of clarity and brevity, the heat exchanger has only been depicted within a furnace (e.g., for a residential space) and a duct (e.g., for a commercial space).

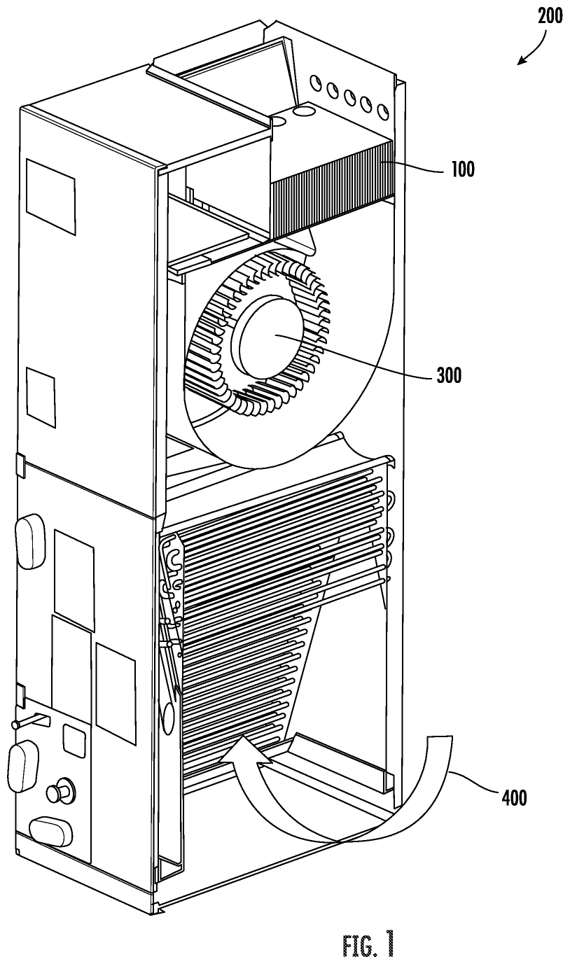

With reference now to the Figures, an exemplary heating, ventilation, and/or air conditioning (HVAC) system 100 is shown in FIG. 1. The HVAC system shown in FIG. 1 may be viewed as a furnace (e.g., for a residential space). The HVAC system 200 includes a heat exchanger 100, and a fan 300. The fan 300 is in airflow communication with the heat exchanger 100. Being in airflow communication may be interpreted to mean that the airflow 400 that is drawn into the HVAC system 200 (e.g., by the fan 300) is passed through both the fan 300 and the heat exchanger 100.

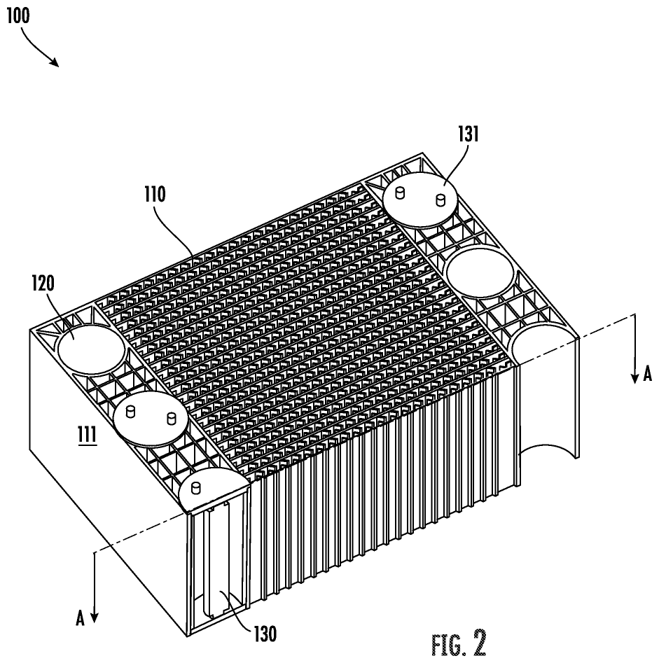

A perspective view of the heat exchanger 100 is shown in FIG. 2. As shown in FIG. 2, the heat exchanger 100 includes a body 110 configured to permit the passage of an airflow 400 through at least a portion of the body 110. The body 110 includes at least one pocket 120. The pocket 120 includes an interior surface 121. Passing an airflow 400 through at least a portion of the body 110 may mean that the airflow 400 may pass through only part of the cross-sectional area of the heat exchanger 100. For example, the airflow 400 may not pass through the cross-sectional area of the heat exchanger 100 where the pocket 120 is configured. The heat exchanger 100 includes at least one bulb 130 configured within at least one pocket 120. By configuring the bulb 130 within the pocket 120 and preventing the airflow 400 from passing through the pocket 120, the heat exchanger 100 may prevent the airflow 400 from coming into direct contact with the bulb 130, which may prevent, or at least mitigate, the bulb 130 from becoming damaged (e.g., by a moist airflow 400).

Each bulb 130 may be supported within each pocket 120 in a way that prevents the bulb 130 from contacting the interior surface 121 of the pocket 120. If allowed to contact the interior surface 121 of the pocket 120 the bulb 130, which in certain instances has a glass exterior, could potentially crack. The likelihood of a bulb 130 cracking may be especially high if the HVAC system 200 vibrates (e.g., which could be caused, at least in part, by the operation of the fan 300). In certain instances, each bulb 130 is supported within each pocket 120 with a plate 131 (as shown in FIG. 2). This plate 131 may be made of ceramic, and may be configured to allow the passage of an electrical power to the bulb 120. For example, the plate 131 may include one or more holes to allow the passage of one or more wires to the bulb 130. It should be appreciated that, in certain instances, the plate 131 and the bulb 130 are configured as one unified structure (e.g., not separable from one another without breaking either the bulb 130 or the plate 131).

To generate heat each bulb 130 may be configured to receive electrical power (e.g., through one or more wired connections through the holes in the plate 131). It is envisioned that, when multiple bulbs 130 are incorporated, the electrical power may be provided either in series or in parallel to the bulbs 130. Regardless of how the electrical power is transferred to the bulbs 130, each bulb 130 may be configured to convert approximately 90% (e.g., ±20%) of the electrical power it receives to heat and approximately 10% (e.g., ±20%) of the electrical power it receives to light. It should be appreciated that the conversion efficiency of electrical power by each bulb 130 (e.g., to light and/or heat) may vary depending on the type of bulb 130 selected and/or the design/configuration of the bulb 130. In certain instances, the heat exchanger 100 utilizes at least one halogen bulb 130.

Each bulb 130 (e.g., halogen bulb) may include a particular filament (e.g., configured in a spiral wire), a particular tube color (e.g., clear, white, ruby, or gold), operate within a particular wavelength (e.g., 2.5 μm), have a certain voltage (e.g., between 12V and 450V), consume a certain amount of electrical power (e.g., 300 W to 4000 W), have a certain color temperature (e.g., 1200 K), define a particular diameter (e.g., between 10 mm and 18 mm), and have a certain lifespan (e.g., 5000 hours). It should be appreciated that each of the above-described variables may vary depending on the type of bulb 130 selected and/or design/configuration of the bulb 130. It is envisioned that any bulb 130 may be incorporated within the heat exchanger 100 so long as the bulb 130 is capable of generating heat. However, the efficiency of the HVAC system 200 may vary depending on the particular bulb 130 selected as certain bulbs 130 may more efficiently generate heat than other bulbs 130.

To increase the efficiency of the HVAC system 200 the interior surface(s) 121 of the pocket(s) 120 may include a black solar coating. This black solar coating may increase the efficiency of the HVAC system 200 by converting at least a portion of the light generated by the bulb(s) 120 to heat. Meaning that a higher proportion of electrical energy may end up as heat when the interior surface(s) 121 of the pocket(s) 120 include a black solar coating. This black solar coating may be made of a plurality (e.g., three or more) of nano-crystalline layers, which may be deposited by a chemical process. This black solar coating may have high durability and high absorption properties (e.g., for temperatures ranging from 500° C. to 800° C.). For example, the black solar coating may absorb 90% to 98% of the light generated by the bulb 130 (e.g., by radiation) and reflect less than 40% back (e.g., having an emissivity of less than 40%).

As described above, each bulb 130 within the heat exchanger 100 is configured to generate a heat. At least a portion of the heat is transferred to at least a portion of the airflow 400. For example, as the airflow 400 passes through the body 110 of the heat exchanger 100, the heat may be transferred from the body 110 of the heat exchanger 100 to the airflow 400 by conduction. To effectively transfer heat to the airflow 400, the bulb(s) may be configured to in a manner that allows heat to transfer from the bulb(s) 120 throughout the body 110. It is envisioned that the bulb(s) 130 may be configured either parallel to the passage of the airflow 400 or perpendicular to the passage of the airflow 400. In certain instances, the heat exchanger 100 may include at least one bulb 130 in parallel to the passage of the airflow 400 and at least one bulb 130 perpendicular to the passage of the airflow 400.

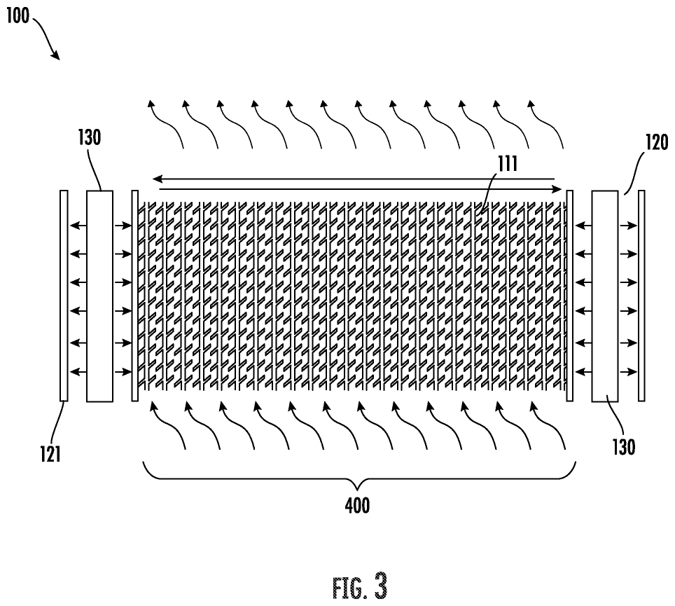

FIGS. 2 and 3 illustrate a heat exchanger 100 with at least one bulb 130 in parallel to the passage of the airflow 400. As shown in FIG. 2, the heat exchanger 100 may include a plurality of pockets 120, one or more of which may include a bulb 130 (e.g., extending in parallel within the pocket 120). Each bulb 130 may be equidistantly placed within each pocket 120. Equidistantly placed may mean that the bulb 120 is no closer to one side of the pocket 120 than another side of the pocket 120. As shown in FIG. 3, each pocket 120 may be disposed on the exterior perimeter of the heat exchanger 100. However, it is envisioned (although not shown) that the heat exchanger 100 may include one or more pocket disposed toward the center of the heat exchanger 100.

As shown in FIG. 3, to transfer heat to the airflow 400 the body 110 of the heat exchanger 100 may be made of an extruded metal (e.g., aluminum, steel, and/or copper). The pockets 120 may be configured within and/or around the perimeter of the extruded metal (e.g., the extruded metal may be manufactured in a way that produces a pocket 120). The heat generated by each bulb 130 is transferred through the extruded metal 111. As the airflow 400 passes through the extruded metal 111 the heat is transferred from the extruded metal 111 to the airflow 400. It should be appreciated that the heat being transferred to the airflow may be generated, at least in part, by the conversion of the light (e.g., produced by the bulb(s) 130) to heat by the black solar coating on the interior surface(s) 121 of the pocket(s) 120.

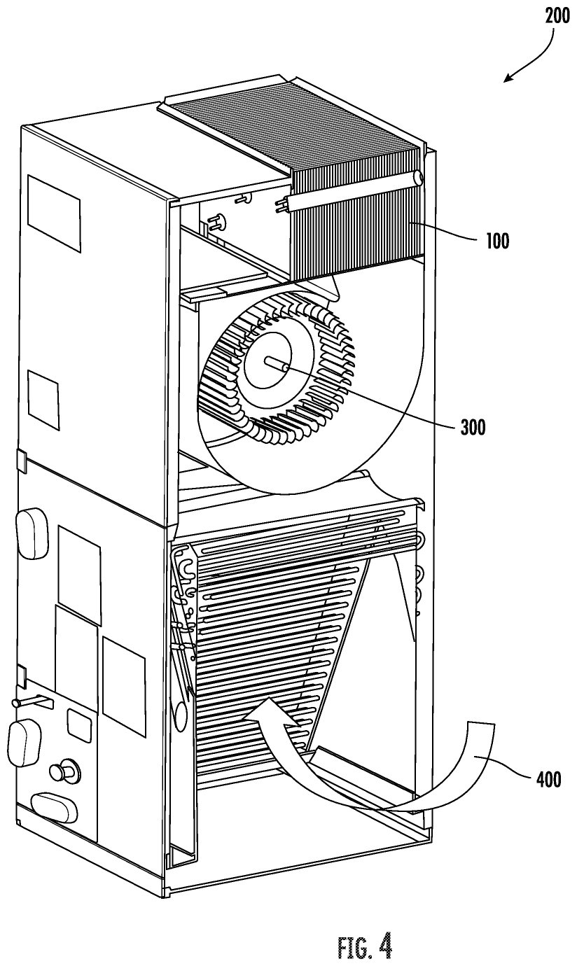

FIG. 4 depicts an exemplary embodiment of an HVAC system 200 including a heat exchanger 100 with at least one bulb 130 perpendicular to the passage of the airflow 400. The heat exchanger 100 may include a plurality of pockets 120, one or more of which may include a bulb 130 (e.g., extending in parallel within the pocket 120). Each bulb 130 may be equidistantly placed within each pocket 120 (e.g., not closer to one side of the pocket 120 than another side of the pocket 120). As shown in FIGS. 4-6, each pocket 120 may be disposed toward the center of the heat exchanger 100 (e.g., away from the perimeter of the heat exchanger 100). However, it is envisioned (although not shown) that the heat exchanger may include one or more pocket disposed toward the perimeter of the heat exchanger 100.

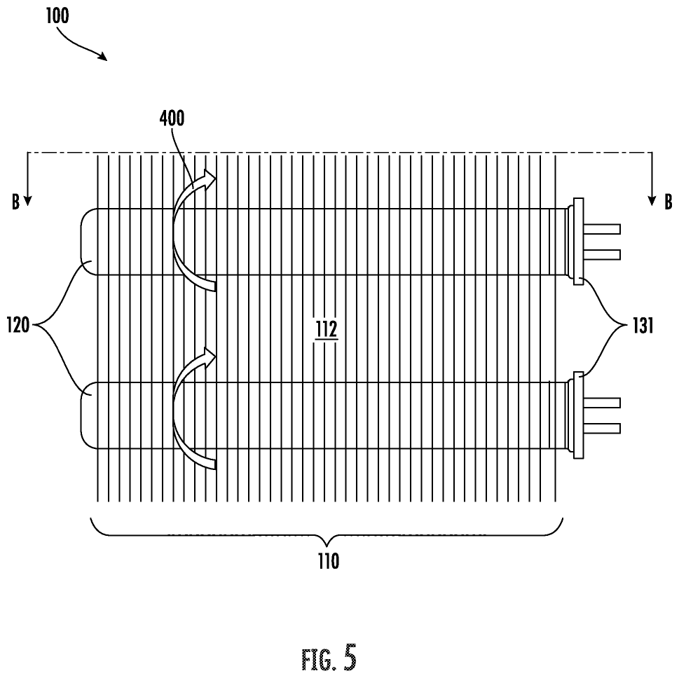

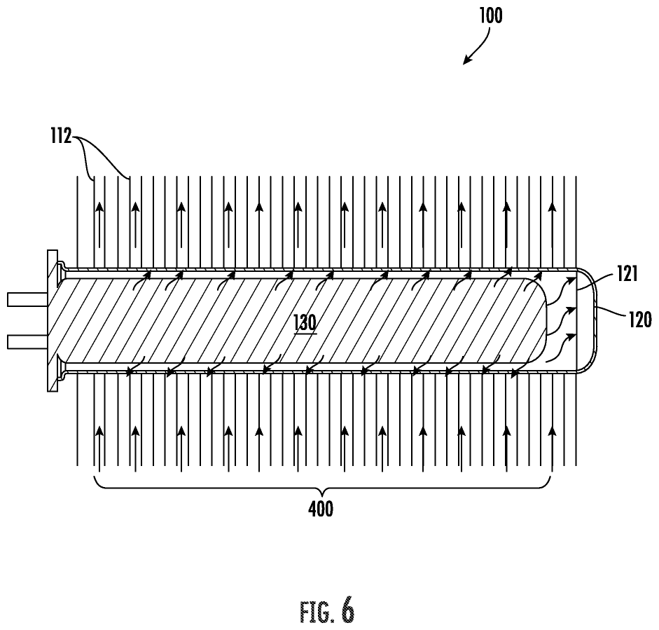

As shown in FIGS. 5 and 6, to transfer heat to the airflow 400 the heat exchanger 100 may include a plurality of fins 112 (e.g., louvered fins). Each fin may be made of a metal (e.g., aluminum, steel, and/or copper). When incorporating at plurality of fins 112, the heat exchanger 100 may be described to be a Round Tube Plate Fin type heat exchanger 100, where the pocket 120 is defined by the interior space within the tube. Each tube may be made of a metal (e.g., aluminum, steel, and/or copper). The tubes (e.g., the interior space of which define pockets 120) may support these fins 111 (e.g., by extending through the fins 112 in a perpendicular manner).

The heat generated by each bulb 130 and the heat generated by the conversion of light (e.g., by the black solar coating on the interior surface(s) 121 of the pocket(s) 120) may be transferred to the fins 112 (e.g., from the pocket(s) 120 to the fins 112 through conduction). The heat generated by each bulb 130 (e.g., which may be disposed within the pocket(s) 120 defined the tubes) is transferred from the bulb(s) 130 to the pocket(s) 120 (e.g., through radiation), and from the pocket(s) 120 to the fins 112 (e.g., through conduction). The heat generated by the conversion of light on the interior surface(s) of the pocket(s) 120 may be transferred through the pocket(s) 120 (e.g., through the tube) to the fins 112 (e.g., through conduction). As the airflow 400 passes through the fins 112, the heat is transferred from the fins 112 to the airflow 400.

The above-described HVAC systems 200 may be particularly useful for providing heat to a residential space. Both the HVAC systems 200 shown in FIGS. 1 and 4 may be viewed as electric furnaces (e.g., with the heat exchanger 100 disposed adjacent to the fan 300). Adjacent to the fan 300 may mean that the heat exchanger 100 is disposed without having a substantial space (e.g., no greater than approximately two feet) between the heat exchanger 100 and the fan 300.

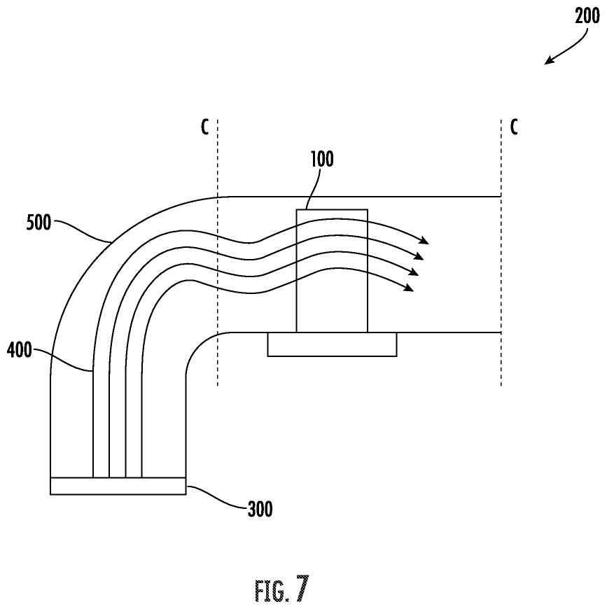

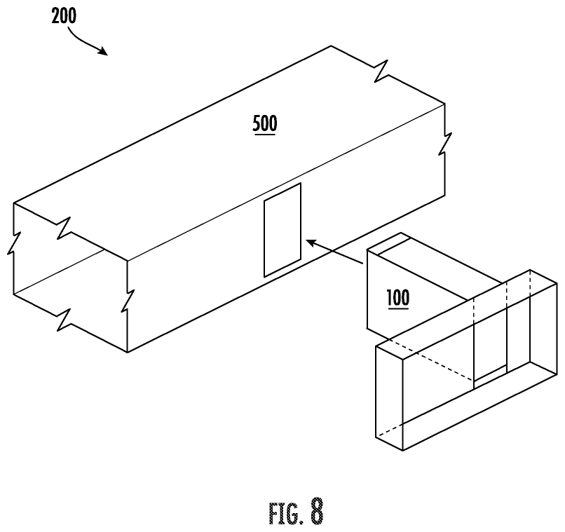

It is envisioned that the heat exchanger 100 may also be useful for providing heat to commercial spaces. An exemplary embodiment of an HVAC system 200 for a commercial space is shown in FIGS. 7 and 8. As shown in FIG. 7, the heat exchanger 100 and the fan 300 may be disposed within a duct 500. A duct 500 is a conduit or passage that is commonly used to deliver and remove air from a space. In certain instances, the heat exchanger 100 is disposed a distance (e.g., greater than 5 feet) from the fan 300 within the duct 500. It is envisioned that when utilizing the heat exchanger 100 within a duct 500, the bulb(s) may be either parallel (as shown in FIGS. 2 and 3) or perpendicular (as shown in FIGS. 5 and 6) with the passage of the airflow 400. Regardless of how oriented, at least a portion of the heat generated by the bulb(s) 130 may be transferred to at least a portion of the airflow 400 (e.g., passing through the duct 500).

Regardless of whether the heat exchanger 100 is incorporated within an HVAC system 200 for a residential or commercial space, the heat exchanger 100 may enable the HVAC system 200 to adjust the amount of heat provided to a space by adjusting the number of bulbs 130 that are turned “ON”. To adjust the number of bulbs 130 that are turned “ON”, the HVAC system 200 may only supply electrical power to the bulbs 130 that are needed to for a given heating requirement. For example, if the HVAC system 200 is configured to be able to provide 4 kW of electric heating using four bulbs 130 and the space requires 4 kW of electric heating, the HVAC system 200 may supply electrical power to all four of the bulbs 130 in the heat exchanger 100. If less heating is required (e.g., only 2 kW) the HVAC system 200 may limit the supply of electrical power (e.g., only provide electrical power two of the bulbs 130). It should be appreciated that each heat exchanger may include more bulbs 130 than is necessary to meet the minimum heating needs of a space. For example, each heat exchanger 100 may be configured to include “extra” bulbs 130 so as to be capable of meeting the minimum heating needs for a space when a bulb 130 fails (e.g., becomes incapable of generating heat and/or light). It is envisioned that the heating capabilities of a heat exchanger 100 may be increased and or decreased by changing the type of bulbs 130 in the heat exchanger 100 (e.g., by replacing existing bulbs 130 with new bulbs with a different wattage).

The use of the terms “a” and “and” and “the” and similar referents, in the context of describing the invention, are to be construed to cover both the singular and the plural, unless otherwise indicated herein or cleared contradicted by context. The use of any and all example, or exemplary language (e.g., “such as”, “e.g.”, “for example”, etc.) provided herein is intended merely to better illuminate the invention and does not pose a limitation on the scope of the invention unless otherwise claimed. No language in the specification should be construed as indicating any non-claimed elements as essential to the practice of the invention.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A heat exchanger comprising:
a body configured to permit the passage of an airflow through at least a portion of the body, the body comprising at least one pocket, the pocket comprising an interior surface; and
at least one bulb configured within at least one pocket, the bulb configured to generate a heat, at least a portion of the heat being transferred to at least a portion of the airflow.

2. The heat exchanger of claim 1, wherein each pocket is configured parallel to the passage of the airflow.

3. The heat exchanger of claim 1, wherein each pocket is configured perpendicular to the passage of the airflow.

4. The heat exchanger of claim 1, wherein each bulb is supported within each pocket by a plate, the plate configured to prevent the bulb from coming into contact with the interior surface of the pocket.

5. The heat exchanger of claim 1, wherein each bulb is configured to receive an electrical power, each bulb configured to convert approximately 90% of the electrical power to heat and approximately 10% of the electrical power to light.

6. The heat exchanger of claim 5, wherein the interior surface of the pocket comprises a black solar coating, the black solar coating configured to convert at least a portion of the light generated by the bulb to heat.

7. The heat exchanger of claim 6, wherein the black solar coating is comprised of a plurality of nano-crystalline layers.

8. The heat exchanger of claim 6, wherein the black solar coating comprises an emissivity less than 40%.

9. The heat exchanger of claim 1, wherein the pocket prevents substantially all of the airflow from coming into contact with the bulb.

10. The heat exchanger of claim 1, wherein the body comprises a plurality of fins, each fin respectively comprised of a metal, the metal comprising at least one of: aluminum, steel, and copper.

11. The heat exchanger of claim 1, wherein the body comprises an extruded metal, the metal comprising at least one of: aluminum, steel, and copper.

12. The heat exchanger of claim 1, wherein the bulb is a halogen bulb.

13. The heat exchanger of claim 1, wherein the body comprises at least four pockets and the heat exchanger comprises at least four bulbs, each respective bulb configured within a pocket.

14. A heating, ventilation, and/or air conditioning (HVAC) system comprising:
a heat exchanger comprising:
a body configured to permit the passage of an airflow through at least a portion of the body, the body comprising at least one pocket, the pocket comprising an interior surface; and
at least one bulb configured within at least one pocket, the bulb configured to generate a heat, at least a portion of the heat being transferred to at least a portion of the airflow; and
a fan in airflow communication with the heat exchanger.

15. The HVAC system of claim 14, wherein the heat exchanger is disposed adjacent to the fan.

16. The HVAC system of claim 14, wherein the HVAC system further comprises a duct, the heat exchanger disposed a distance from the fan in the duct.

17. The HVAC system of claim 14, wherein each pocket is configured parallel to the passage of the airflow.

18. The HVAC system of claim 14, wherein each pocket is configured perpendicular to the passage of the airflow.

19. The HVAC system of claim 14, wherein the pocket prevents substantially all of the airflow from coming into contact with the bulb.

20. The HVAC system of claim 14, wherein the heat exchanger comprises at least one of: a plurality of fins and an extruded metal.
